(19) United States
(12) Patent Application Publication
(10) Pub. No.: US 2019/0271875 A1
(43) Pub. Date: Sep. 5, 2019

(54) BUFFERING DEVICE, METHOD FOR MANUFACTURING BUFFERING DEVICE, BACKLIGHT MODULE, DISPLAY DEVICE AND METHOD FOR MANUFACTURING DISPLAY DEVICE

(71) Applicants: BOE TECHNOLOGY GROUP CO., LTD., Beijing (CN); CHENGDU BOE OPTOELECTRONICS TECHNOLOGY CO., LTD., Chengdu (CN)

(72) Inventors: Bing Xu, Beijing (CN); Junping Bao, Beijing (CN); Xinbo Yu, Beijing (CN); Xiangfu Jin, Beijing (CN)

(21) Appl. No.: 16/129,253

(22) Filed: Sep. 12, 2018

(30) Foreign Application Priority Data
Mar. 1, 2018 (CN) 201810171920.8

(51) Int. Cl. G02F 1/1333; G02F 1/13; G02F 1/13357

(52) U.S. Cl. CPC G02F 1/133308; G02F 1/1303; G02F 2001/133322; G02F 2001/133317; G02F 2001/133325; G02F 1/1336

(57) ABSTRACT

A buffering device, a method for manufacturing the buffering device, a backlight module, a display device and a method for manufacturing the display device are provided. The buffering device includes a buffering body and a hollowed-out buffering layer arranged on a surface of the buffering body. The hollowed-out buffering layer includes a plurality of hollowed-out portions and a plurality of non-hollowed-out portions, each of the plurality of hollowed-out portions comprises an adhesive layer having a thickness smaller than a thickness of each of the plurality of non-hollowed-out portions, regions of the surface of the buffering body are configured to arrange the plurality of hollowed-out portions, and the adhesive layer is arranged in the regions.

### CROSS-REFERENCE TO RELATED APPLICATION

The present application claims priority to Chinese patent application No. 201810171920.8 filed on Mar. 1, 2018, which is incorporated herein by reference in its entirety.

### BACKGROUND

The present disclosure relates to the field of display technology, and particularly to a buffering device, a method for manufacturing the buffering device, a backlight module, a display device, and a method for manufacturing the display device.

Due to advantages such as excellent image quality, a thin profile, and low power consumption, liquid crystal displays (LCDs) are used widely in mobile display devices, consumer communication devices, and consumer electronic products.

### SUMMARY

A buffering device includes a buffering body and a hollowed-out buffering layer arranged on a surface of the buffering body. The hollowed-out buffering layer includes a plurality of hollowed-out portions and a plurality of non-hollowed-out portions. Each of the plurality of hollowed-out portions includes an adhesive layer having a thickness smaller than a thickness of each of the plurality of non-hollowed-out portions. Regions of the surface of the buffering body are configured to arrange the plurality of hollowed-out portions, and the adhesive layer is arranged in the regions.

In some embodiments, any two adjacent hollowed-out portions are spaced apart from each other at a same distance.

In some embodiments, the plurality of hollowed-out portions is arranged in a matrix form, and the plurality of non-hollowed-out portions is connected to each other to form one piece.

In some embodiments, the plurality of non-hollowed-out portions is arranged in a matrix form, and the plurality of hollowed-out portions is connected to each other to form one piece.

In some embodiments, the plurality of hollowed-out portions and the plurality of non-hollowed-out portions are arranged parallel to each other, one hollowed-out portion is arranged between two adjacent non-hollowed-out portions, and one non-hollowed-out portion is arranged between two adjacent hollowed-out portions.

In some embodiments, each of the plurality of hollowed-out portions and the plurality of non-hollowed-out portions is of a strip shape, and a length of each hollowed-out portion in an extending direction is smaller than or equal to a length of the buffering body in the extending direction of the hollowed-out portion.

In some embodiments, each non-hollowed-out portion has a thickness of 0.25 mm to 1 mm, and a thickness direction of each non-hollowed-out portion is perpendicular to the surface of the buffering body.

In some embodiments, the buffering body and the hollowed-out buffering layer are each made of an elastic material.

In some embodiments, the buffering body is a buffering adhesive tape.

In some embodiments, the buffering body is foam adhesive tape.

A backlight module includes the above-mentioned buffering device.

In some embodiments, the backlight module further includes a module body. The module body includes a light-exiting side which includes a light-exiting region and a bezel region. The buffering body is arranged in the bezel region, and the hollowed-out buffering layer is arranged on a surface of the buffering body away from the bezel region.

A display device includes the above-mentioned backlight module.

A method for manufacturing a buffering device includes forming a hollowed-out buffering layer on a surface of a buffering body. The buffering device includes the buffering body and the hollowed-out buffering layer arranged on a surface of the buffering body. The hollowed-out buffering layer includes a plurality of hollowed-out portions and a plurality of non-hollowed-out portions. Each of the plurality of hollowed-out portions includes an adhesive layer having a thickness smaller than a thickness of each of the plurality of non-hollowed-out portions. Regions of the surface of the buffering body are configured to arrange the plurality of hollowed-out portions, and the adhesive layer is arranged in the regions.

In some embodiments, the buffering body is a buffering adhesive tape, and the forming the hollowed-out buffering layer on the surface of the buffering body includes forming the hollowed-out buffering layer on an adhesive surface of the buffering adhesive tape.

In some embodiments, the buffering body is a foam adhesive tape, and the forming the hollowed-out buffering layer on the surface of the buffering body includes forming the hollowed-out buffering layer on an adhesive surface of the foam adhesive tape.

In some embodiments, the buffering body is a buffering pad, and the forming the hollowed-out buffering layer at the surface of the buffering body includes attaching an adhesion backsize on a surface of the buffering pad and forming the hollowed-out buffering layer on a surface of the adhesion backsize away from the buffering pad.

A method for manufacturing a display device includes: providing a display panel and a backlight module, wherein the backlight module includes a buffering device comprising a buffering body and a hollowed-out buffering layer arranged on a surface of the buffering body, the hollowed-out buffering layer includes a plurality of hollowed-out portions and a plurality of non-hollowed-out portions, each of the plurality of hollowed-out portions includes an adhesive layer having a thickness smaller than a thickness of each of the plurality of non-hollowed-out portions, regions of the surface of the buffering body are configured to arrange the plurality of hollowed-out portions, and the adhesive layer is arranged in the regions; controlling a surface of the hollowed-out buffering layer adjacent to the display panel to be in contact with a light-entering surface of the display panel, to provide a gap between the adhesive layer and the light-entering surface of the display panel; and adjusting a position of the display panel relative to the backlight module in a condition that there is an alignment error between the display panel and the backlight module, and controlling the adhesive layer to be attached to the light-entering surface of the display panel after the display panel being aligned correctly with the backlight module.

### BRIEF DESCRIPTION OF THE DRAWINGS

FIG. 1 is a schematic view showing a situation where a buffering device abuts against a display panel when a sealant between a backlight module and the display panel has an uneven surface in the related art.

FIG. 2 is a schematic view showing a situation where the buffering device abuts against the display panel when the sealant between the backlight module and the display panel is deformed in the related art.

FIG. 3 is a schematic view showing the buffering device and the display panel when a first sealant surface protrudes toward the display panel in the related art.

FIG. 4 is a schematic view showing a situation where the display panel is pulled by the buffering device toward the backlight module in the related art.

FIG. 5 is a side view of a buffering device according to some embodiments.

FIG. 6 is a schematic view showing the buffering device and a display device when a surface of a first sealant protrudes toward a display panel according to some embodiments.

FIG. 7 is a schematic view showing a situation where the display panel is pulled by the buffering device toward a backlight module according to some embodiments.

FIG. 8 is a three-dimensional view of the buffering device according to some embodiments.

FIG. 9 is another three-dimensional view of the buffering device according to some embodiments.

FIG. 10 is another three-dimensional view of the buffering device according to some embodiments.

FIG. 11 is another three-dimensional view of the buffering device according to some embodiments.

FIG. 12 is a schematic view showing a display device according to some embodiments.

FIG. 13 is a flow chart of a method for manufacturing the display device according to some embodiments.

FIG. 14 is a schematic view showing the display device manufactured according to steps of the method in the FIG. 13.

### DETAILED DESCRIPTION

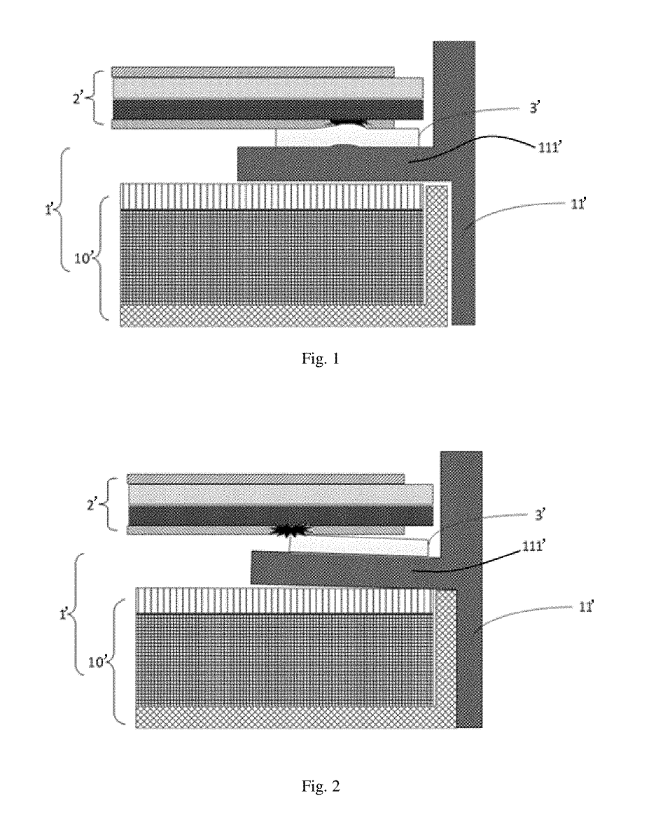

FIG. 1 is a schematic view showing a situation in the related art wherein a buffering device abuts against a display panel when a sealant between a backlight module and the display panel has an uneven surface. FIG. 2 is a schematic view showing a situation in the related art wherein the buffering device abuts against the display panel when the sealant between the backlight module and the display panel is deformed. As shown in FIGS. 1 and 2, a display panel 2′ is arranged at a side of a light-exiting surface of the backlight module. The backlight module 1′ includes a module body 10′, a sealant 11′ and a buffering device 3′. A portion of the sealant 11′ between the module body 10′ and the display panel 2′ is a first sealant 111′. The buffering device 3′ is arranged between the first sealant 111′ and the display panel 2′, and an adhesive layer is arranged on a surface of the buffering device 3′ adjacent to the display panel 2′.

As shown in FIGS. 1 and 2, it is able for the adhesive layer on the surface of the buffering device 3′ to prevent foreign matters from entering a gap between the backlight module 1′ and the display panel 2′. The buffering device 3′ may be a buffering pad.

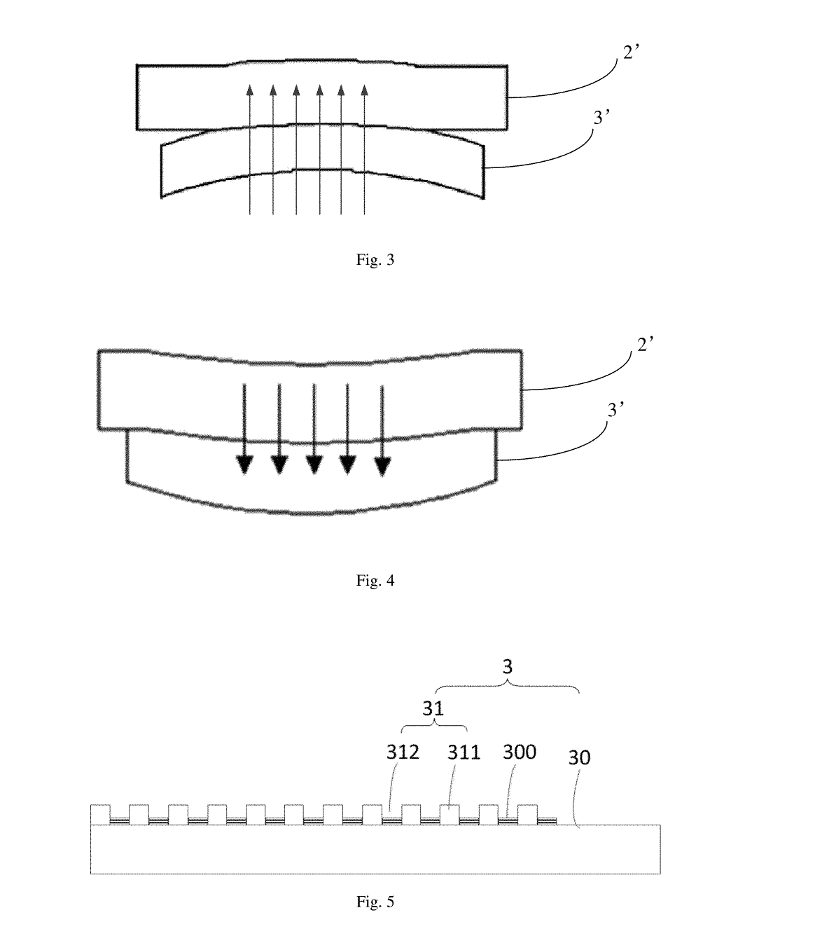

In a condition that the first sealant has an uneven surface, the display panel under stress may refer to FIGS. 3 and 4. FIG. 3 is a schematic view showing the buffering device and the display panel when a first sealant surface protrudes toward the display panel in the related art. As shown in FIG. 3, the first sealant surface 11′ protrudes toward the display panel, leading the buffering device 3′ protruding toward the display panel too, thereby abutting against a surface of the display panel 2′, which applying a force to the surface of the display panel 2′.

FIG. 4 is a schematic view showing a situation where the display panel is pulled by the buffering device toward the backlight module in the related art. For example, in a condition that the first sealant surface 11′ is depressed toward the backlight module, as shown in FIG. 4, the display panel 2′ is pulled by the buffering device 3′ toward the backlight module 1′.

As shown in FIGS. 3 and 4, when a surface of the first sealant 11′ is uneven, a force is applied by the buffering device 3′ onto the display panel 2′. For the display panel 2′ in a dark state, such a phenomenon as being whitish and shiny may occur in a region of the display panel 2′ where the force has been applied, thereby L0 light leakage occurring.

Due to the adhesive layer on the surface of the buffering device 3′, when the display panel 2′ is attached onto the backlight module 1′ in a misalignment manner, it is impossible to adjust a position of the display panel 2′ relative to the backlight module 1′. Due to the misalignment between the display panel 2′ and the backlight module 1′, the quality of a display device may be adversely affected.

In some embodiments, as shown in FIG. 5, a buffering device 3 includes a buffering body 30 and a hollowed-out buffering layer 31 arranged on the buffering body 30. The hollowed-out buffering layer 31 includes a plurality of hollowed-out portions 312 and a plurality of non-hollowed-out portions 311, and each of the plurality of hollowed-out portions 312 includes an adhesive layer 300 having a thickness smaller than a thickness of each of the plurality of non-hollowed-out portions 311. The adhesive layer 300 is arranged in regions of the surface of the buffering body 30, and the regions are configured to arrange the plurality of hollowed-out portions 312. One first surface is configured to arrange one of the plurality of hollowed-out portions 312.

The thickness of the adhesive layer refers to a distance between a surface of the adhesive layer away from the buffering body and a surface of the buffering body adjacent to the adhesive layer. The thickness of one non-hollowed-out portion refers to a distance between a surface of the non-hollowed-out portion away from the buffering body and a surface of the buffering body adjacent to the non-hollowed-out portion. A direction of the thickness of the adhesive layer and a direction of the thickness of the non-hollowed-out portion are perpendicular to a surface of the buffering body in contact with the plurality of non-hollowed-out portions.

In some embodiments, the buffering body 30 and the hollowed-out buffering layer 31 of the buffering device 3 are made of an elastic material.

A portion of a sealant between a backlight module 1 and a display panel 2 is a first sealant 111. In some embodiments, the buffering device 3 is arranged on the first sealant 111, and the hollowed-out buffering layer 31 is arranged on a surface of the buffering body 30 away from the first sealant 111.

According to the buffering device 3 in above embodiments, the hollowed-out buffering layer 31 is arranged on the buffering body 30, the adhesive layer 300 is arranged in the regions of the surface of the buffering body 30. When the backlight module 1 is assembled with the display panel 2, a surface of the hollowed-out buffering layer 31 away from the backlight module is in contact with a light-entering surface of the display panel 2, and a gap is provided between the adhesive layer 300 and the light-entering surface of the display panel 2, so it is able for the display panel 2 to be in pre-contact with the backlight module 1.

In other words, when the display panel 2 is misaligned with the backlight module 1, the position of the display panel 2 relative to the backlight module 1 may be adjusted, to enable the display panel 2 to be correctly aligned with the backlight module 1 and enable the adhesive layer 300 to be adhered to the light-entering surface of the display panel 2 after the alignment, thereby to enable the backlight module 1 to be adhered to the display panel 2.

In above embodiments, in the condition that the backlight module 1 is not in complete contact with and misaligned with the display panel 2, the position of the display panel 2 relative to the backlight module 1 may be adjusted under an elastic force provided by the non-hollowed-out portions 311 of the hollowed-out buffering layer 31. As a result, applying the buffer device to the assembling of the display device reduces the number of reworking times as well as the loss of work, improves the quality of the display device, and prevents the occurrence of display defects caused by assembling operation not being reworked or the assembling operation being reworked forcibly.

In the above embodiments, the thickness of the adhesive layer is smaller than the thickness of the non-hollowed-out portion, leading the display panel 2 being completely adhered to the surface of each non-hollowed-out portion 311 in a condition that the display panel 2 is attached to the adhesive layer 300. In this way, it is able to prevent foreign matters from entering the gap between the display panel 2 and the backlight module 1.

In the related art, as shown in FIGS. 1-3, the buffering pad (i.e., the buffering device 3′) is arranged on the sealant 11′ of the backlight module 1′, and the adhesive layer is arranged on the surface of the buffering pad in contact with the display panel 2′. In a condition that the first sealant surface 111′ protrudes toward the display panel 2′ or the sealant 11′ is deformed (i.e., one end of the first sealant 111′ is curled toward the display panel 2′), the buffering device 3′ is jacked up and applies a force to the display panel 2′, applying a force to the display panel 2′. As shown in FIGS. 1, 2 and 4, when a bezel of the backlight module 1′ is depressed in a direction away from the display panel 2′, the display panel 2′ is pulled by the buffering device 3′ toward the backlight module 1′, leading a pulling force being applied to the display panel 2′ at a position which is pulled by the backlight module 1′.

As shown in FIG. 5, the adhesive layer 300 having a thickness smaller than a thickness of each non-hollowed-out portion 311 is arranged in the regions of the surface of the buffering body 30, and each hollowed-out portion 312 is arranged between two adjacent non-hollowed-out portions 311. Compared with the related art where the adhesive layer is arranged on the entire surface of the buffering pad, the buffering device in above embodiments is able to reduce an area of the adhesive layer between the backlight module and the display panel, and dispersedly form the adhesive layer on the surface of the buffering body, thereby to facilitate the contact of the adhesive layer with the display panel.

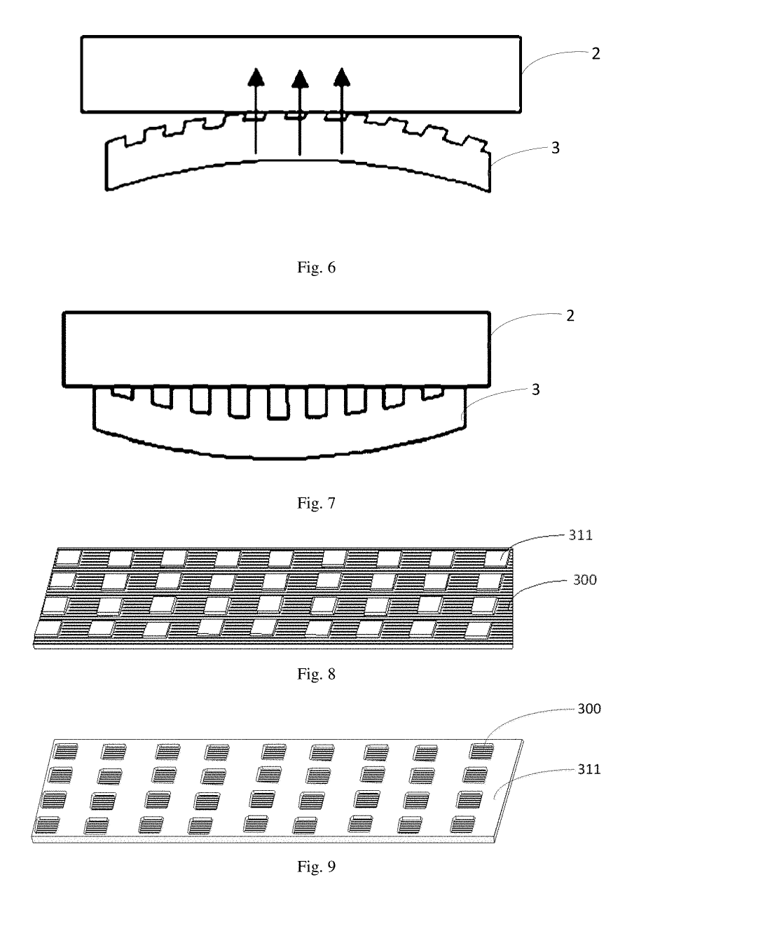

As shown in FIG. 6, when the surface of the buffering device 3 protrudes toward the display panel, compared with the force applied to the display panel 2′ in FIG. 3, a smaller force is applied by the buffering device 3 to the display panel 2, so it is able to reduce the stress generated by the display panel 2.

As shown in FIG. 7, when the display panel 2 is pulled by the buffering device 3 toward the backlight module 1, compared with a force applied to the display panel 2′ in FIG. 4, a smaller pulling force is applied by the buffering device 3 to the display panel 2 toward the backlight module 1, so it is able to reduce the probability of the stress generated by the display panel 2, thereby preventing the occurrence of L0 light leakage. A display device in which the bezel of the backlight module 1 is easily deformed, e.g., a vehicle-mounted display device, is provided with the buffering device in above embodiments, preventing the occurrence of display abnormalities caused due to the unevenness of the surface of the backlight module 1.

In some embodiments, the buffering body 30 is a buffering adhesive tape. In some embodiments, the buffering body 30 is a foam adhesive tape. The hollowed-out buffering layer 31 is arranged on an adhesive surface of the buffering adhesive tape or the foam adhesive tape. In some embodiments, the buffering body 30 is a buffering pad, and the adhesive layer 300 is arranged on a surface of the buffering pad.

As shown in FIG. 5, the plurality of hollowed-out portions 312 is arranged evenly on the buffering body 30, and the adhesive layer 300 is arranged in the regions of the surface of the buffering body 30, i.e., a complete adhesive layer is divided into a plurality of adhesive portions which is arranged evenly on the buffering body 30. The buffering device 3 is used to adhere the display panel 2 and the backlight module 1 using the plurality of adhesive portions, thereby improving the adhesion stability. When a bezel of the backlight module 1 is depressed in a direction away from the display panel 2, an even pulling force may be applied to the display panel 2 in a direction facing the backlight module 1. In this way, it is able to prevent the occurrence of the L0 light leakage due to the uneven pulling force applied to the display panel.

The plurality of hollowed-out portions 312 and the plurality of non-hollowed-out portions 311 may be arranged in the following two forms.

In some embodiments, the plurality of hollowed-out portions 312 and the plurality of non-hollowed-out portions 311 are arranged in a matrix form. In some embodiments, as shown in FIG. 8, the plurality of non-hollowed-out portions 311 is arranged in a matrix form, and the plurality of hollowed-out portions 312 where the adhesive layer 300 is arranged is connected to each other to form one piece. In some embodiments, as shown in FIG. 9, the plurality of hollowed-out portions 312 where the adhesive layer 300 is arranged is arranged in a matrix form, and the plurality of non-hollowed-out portions 311 is connected to each other to form one piece.

In some embodiments, the plurality of hollowed-out portions 312 and the plurality of non-hollowed-out portions 311 are arranged parallel to each other.

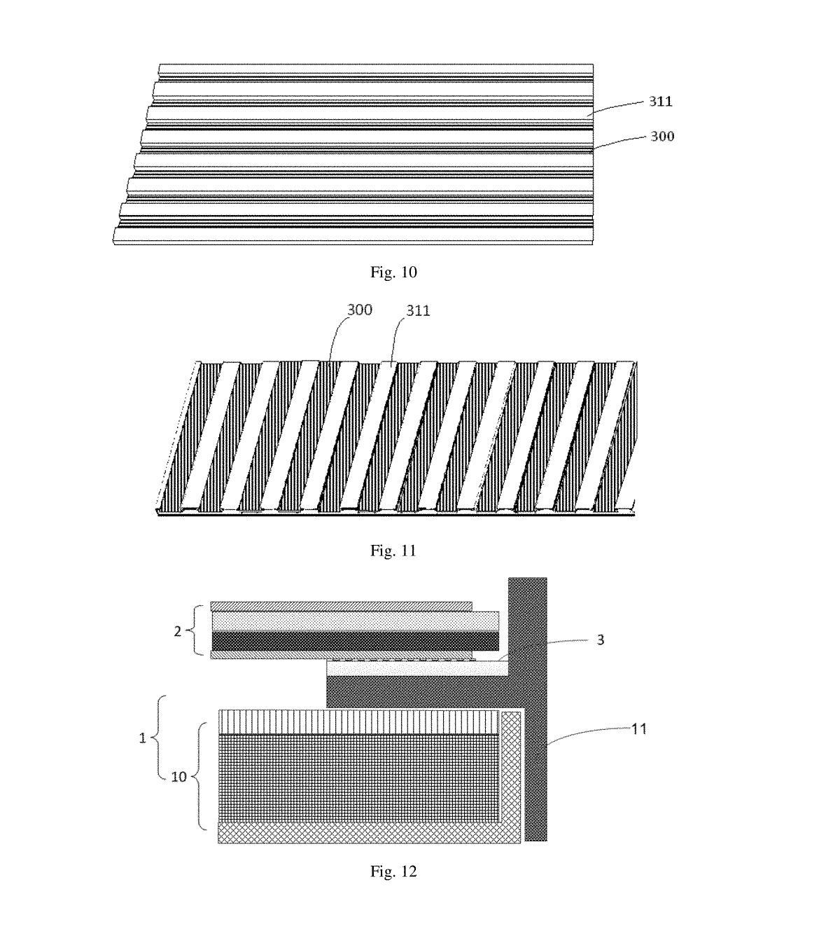

In some embodiments, as shown in FIG. 10, each of the hollowed-out portions 312 where the adhesive layer 300 is arranged and the non-hollowed-out portions 311 is of a strip shape, and the plurality of hollowed-out portions 312 where the adhesive layer 300 is arranged parallel to the plurality of non-hollowed-out portions 311, and one hollowed-out portion 312 is arranged between two adjacent non-hollowed-out portions 311.

In some embodiments, as shown in FIG. 11, each of the hollowed-out portions 312 where the adhesive layer 300 is arranged and the non-hollowed-out portions 311 is of a strip shape, and the plurality of hollowed-out portions 312 where the adhesive layer 300 is arranged and the plurality of non-hollowed-out portions 311 are arranged parallel to each other, and one non-hollowed-out portion 311 is arranged between two adjacent hollowed-out portions 312.

In some embodiments, when each non-hollowed-out portion 311 is of a strip shape, a length of each hollowed-out portion 312 in an extending direction is smaller than or equal to a length of the buffering body 30 in the extending direction of the hollowed-out portion 312. The extending direction is an extending direction of a longest side of a projection of the each hollowed-out portion 312 on the buffering body 30.

The larger the thickness of the non-hollowed-out portion 311 of the hollowed-out buffering layer 31, the larger a thickness of the display panel 2 is. In some embodiments, a direction of the thickness of each non-hollowed-out portion 311 is perpendicular to the surface of the buffering body 30. The thickness L of each non-hollowed-out portion 311 of the hollowed-out buffering layer 31 ranges from 0.25 mm to 1 mm. A thickness of the hollowed-out buffering layer 31 is the thickness of the non-hollowed-out portion 311 of the hollowed-out buffering layer 31. A thickness of the adhesive layer 300 is smaller than the thickness of the non-hollowed-out portion 311, to buffering a force applied by the display panel 2 onto the buffering device 3 when the display panel 2 is in pre-contact with the backlight module 1. The display panel 2 is not in contact with, or not completely adhered to, the adhesive layer 300 on the buffering body 30, to adjust timely the position of the display panel 2 relative to the backlight module 1 when the display panel 2 is misaligned with the backlight module 1. In this way, when the display panel 2 is in pre-contact with the backlight module 1, it is able to prevent the display panel 2 from being directly adhered to the adhesive layer 300 on the buffering body 30 due to a too small difference between the thickness of the non-hollowed-out portion 311 and the thickness of the adhesive layer 300.

In some embodiments, a method for manufacturing the buffering device is provided, and the method includes forming the hollowed-out buffering layer on an adhesive surface of the buffering adhesive tape or the foam adhesive tape. In some embodiments, the method includes attaching an adhesion backsize on a surface of the buffering pad and forming the hollowed-out buffering layer on a surface of the adhesion backsize away from the buffering pad.

In some embodiments, as shown in FIG. 12, the backlight module 1 includes a module body 10, and the module body 10 is provided at one side of its light-exiting side with a light-exiting region and a bezel region. The buffering body 30 of the buffering device 3 is formed in the bezel region, and the hollowed-out buffering layer 31 is arranged on a surface of the buffering body 30 away from the bezel region. The light-exiting region refers to a surface of the backlight module 1 adjacent to the display panel 2 and not covered by the sealant 11, and the bezel region refers to a surface of the backlight module 1 adjacent to the display panel 2 and covered by the sealant 11.

As shown in FIG. 12, a display device is provided and includes the backlight module 1 and the display panel 2. The backlight module 1 includes the buffering device 3. The buffering device 3 includes the buffering body 30 and the hollowed-out buffering layer 31 arranged on the buffering body 30. The display panel 2 is arranged on a side of a light-exiting surface of the backlight module 1, and a surface of the hollowed-out buffering layer 31 away from the buffering body 30 is in contact with a light-entering surface of the display panel 2. The buffering device 3 is arranged between the backlight module 1 and the display panel 2, and the hollowed-out buffering layer 31 includes a plurality of hollowed-out portions 312 and a plurality of non-hollowed-out portions 311. The backlight module 1 further includes the module body 10 and the sealant 11.

In some embodiments, the display device is any product or member having a display function, e.g., a mobile phone, a flat panel computer, a television, a display, a laptop computer, a digital photo frame or a navigator.

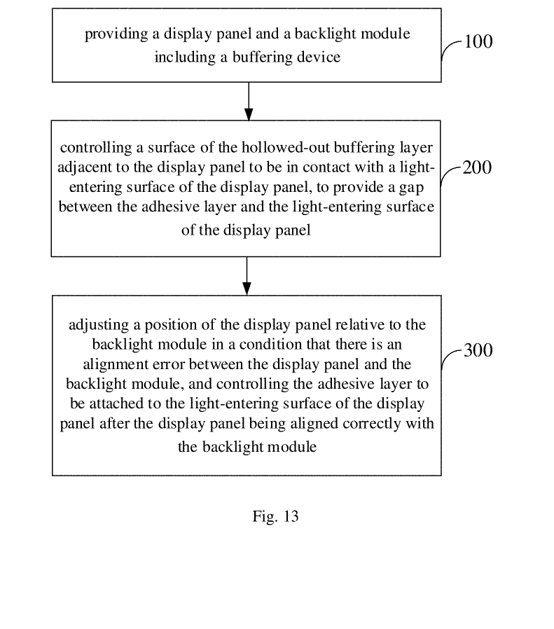

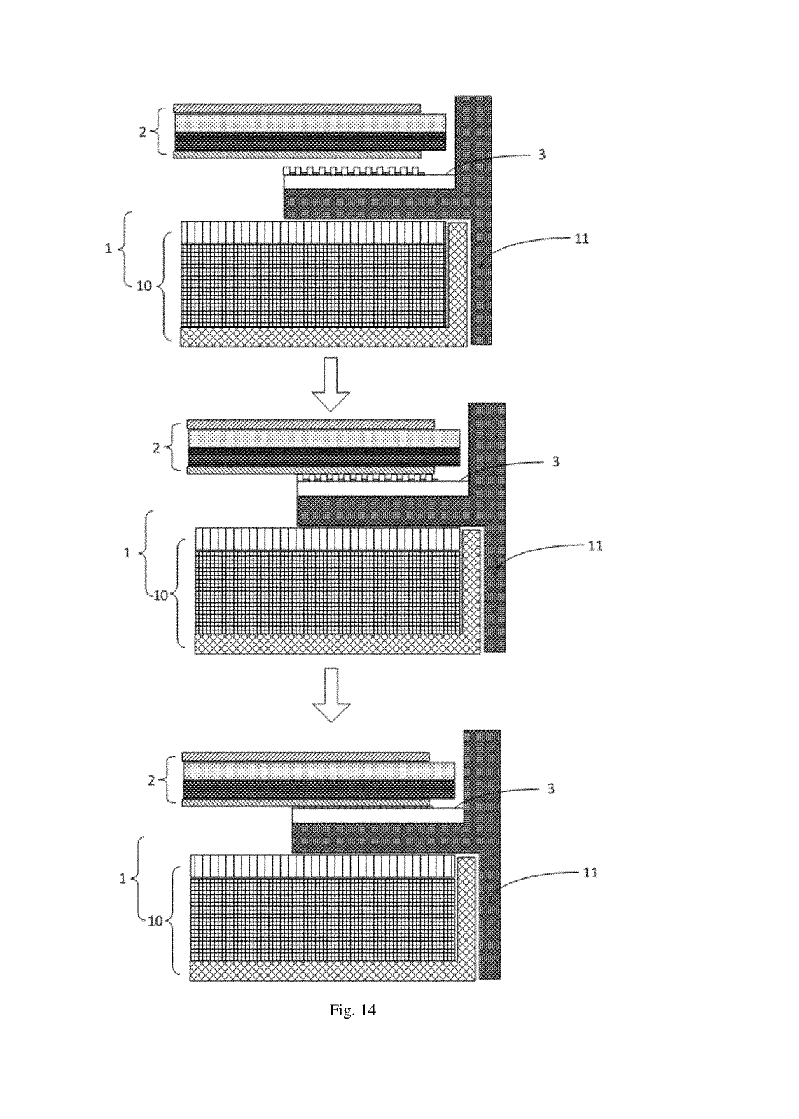

In some embodiments, as shown in FIGS. 13 and 14, a method for manufacturing the display device, includes step 100, step 200 and step 300.

In step 100, the display panel 2 and the backlight module 1 including the above-mentioned buffering device 3 are provided.

In step 200, a surface of the hollowed-out buffering layer 31 adjacent to the display panel is controlled to be in contact with a light-entering surface of the display panel 2, to provide a gap between the adhesive layer 300 and the light-entering surface of the display panel 2.

In step 300, in the condition that there is an alignment error between the display panel 2 and the backlight module 1, a position of the display panel 2 relative to the backlight module 1 is adjusted, and the adhesive layer 300 is controlled to be attached to the light-entering surface of the display panel 2 after the display panel 2 has been aligned correctly with the backlight module 1, obtaining the display device.

When the surface of the hollowed-out buffering layer 31 adjacent to the display panel is in contact with the light-entering surface of the display panel 2, a surface of each non-hollowed-out portion 311 of the hollowed-out buffering layer 31 is in contact with the display panel 2, to provide the gap between the adhesive layer 300 and the light-entering surface of the display panel 2. In other words, when the surface of the hollowed-out buffering layer 31 adjacent to the display panel is in contact with the display panel 2, the thickness of the adhesive layer 300 is smaller than the thickness of the non-hollowed-out portion 311, to ensure the formation of the gap between the adhesive layer 300 in the regions of the surface of the buffering body and the light-entering surface of the display panel 2. As a result, during the adjustment of the position of the display panel relative to the backlight module, it is able to prevent the adjustment from being adversely affected by the adhesive layer arranged in the regions of the surface of the buffering body.

1. A buffering device comprising:
a buffering body; and
a hollowed-out buffering layer arranged on a surface of the buffering body;
wherein:
the hollowed-out buffering layer comprises a plurality of hollowed-out portions and a plurality of non-hollowed-out portions,
each of the plurality of hollowed-out portions comprises an adhesive layer having a thickness smaller than a thickness of each of the plurality of non-hollowed-out portions,
regions of the surface of the buffering body are configured to arrange the plurality of hollowed-out portions, and
the adhesive layer is arranged in the regions.

2. The buffering device according to claim 1, wherein any two adjacent hollowed-out portions of the plurality of hollowed-out portions are spaced apart from each other by a same distance.

3. The buffering device according to claim 1, wherein the plurality of hollowed-out portions is arranged in a matrix form, and the non-hollowed-out portions are connected to each other to form one piece.

4. The buffering device according to claim 1, wherein the plurality of non-hollowed-out portions is arranged in a matrix form, and the hollowed-out portions are connected to each other to form one piece.

5. The buffering device according to claim 1, wherein the plurality of hollowed-out portions and the plurality of non-hollowed-out portions are arranged parallel to each other, one of the plurality of hollowed-out portions is arranged between two adjacent non-hollowed-out portions of the plurality of non-hollowed-out portions, and one of the plurality of non-hollowed-out portions is arranged between two adjacent hollowed-out portions of the plurality of hollowed-out portions.

6. The buffering device according to claim 5, wherein the each of the plurality of hollowed-out portions and the plurality of non-hollowed-out portions is of a strip shape, and a length of the each of the plurality of hollowed-out portions in an extending direction is smaller than or equal to a length of the buffering body in the extending direction of the each of the plurality of hollowed-out portions.

7. The buffering device according to claim 1, wherein the each of the plurality of non-hollowed-out portions has a thickness ranging from 0.25 mm to 1 mm, and a direction of a thickness of the each of the plurality of non-hollowed-out portions is perpendicular to the surface of the buffering body.

8. The buffering device according to claim 1, wherein the buffering body and the hollowed-out buffering layer are made of an elastic material.

9. The buffering device according to claim 8, wherein the buffering body is a buffering adhesive tape.

10. The buffering device according to claim 8, wherein the buffering body is foam adhesive tape.

11. A backlight module comprising the buffering device according to claim 1.

12. The backlight module according to claim 11, further comprising a module body, wherein the module body comprise a light-exiting side comprising a light-exiting region and a bezel region, the buffering body is arranged in the bezel region, and the hollowed-out buffering layer is arranged on a surface of the buffering body away from the bezel region.

13. A display device comprising the backlight module according to claim 11.

14. The display device according to claim 13, wherein the backlight module further comprising a module body, wherein the module body comprise a light-exiting side comprising a light-exiting region and a bezel region, the buffering body is arranged in the bezel region, and the hollowed-out buffering layer is arranged on a surface of the buffering body away from the bezel region.

15. A method for manufacturing a buffering device, the method comprising:
forming a hollowed-out buffering layer on a surface of a buffering body;
wherein:
the buffering device comprises the buffering body and the hollowed-out buffering layer arranged on a surface of the buffering body,
the hollowed-out buffering layer comprises a plurality of hollowed-out portions and a plurality of non-hollowed-out portions,
each of the plurality of hollowed-out portions comprises an adhesive layer having a thickness smaller than a thickness of each of the plurality of non-hollowed-out portions,
regions of the surface of the buffering body are configured to arrange the plurality of hollowed-out portions, and
the adhesive layer is arranged in the regions.

16. The method according to claim 15, wherein the buffering body is a buffering adhesive tape; and
the forming the hollowed-out buffering layer on the surface of the buffering body comprises forming the hollowed-out buffering layer on an adhesive surface of the buffering adhesive tape.

17. The method according to claim 15, wherein the buffering body is a foam adhesive tape; and
the forming the hollowed-out buffering layer on the surface of the buffering body comprises forming the hollowed-out buffering layer on an adhesive surface of the foam adhesive tape.

18. The method according to claim 15, wherein the buffering body is a buffering pad; and
the forming the hollowed-out buffering layer on the surface of the buffering body comprises attaching an adhesion backsize on a surface of the buffering pad and forming the hollowed-out buffering layer on a surface of the adhesion backsize away from the buffering pad.

19. A method for manufacturing a display device, the method comprising:
providing a display panel and a backlight module, wherein the backlight module comprises a buffering device comprising a buffering body and a hollowed-out buffering layer arranged on a surface of the buffering body, the hollowed-out buffering layer comprises a plurality of hollowed-out portions and a plurality of non-hollowed-out portions, each of the plurality of hollowed-out portions comprises an adhesive layer having a thickness smaller than a thickness of each of the plurality of non-hollowed-out portions, regions of the surface of the buffering body are configured to arrange the plurality of hollowed-out portions, and the adhesive layer is arranged in the regions;
controlling a surface of the hollowed-out buffering layer adjacent to the display panel to be in contact with a light-entering surface of the display panel, to provide a gap between the adhesive layer and the light-entering surface of the display panel; and
adjusting a position of the display panel relative to the backlight module in a condition that there is an alignment error between the display panel and the backlight module, and controlling the adhesive layer to be attached to the light-entering surface of the display panel after the display panel being aligned correctly with the backlight module.
